(19) United States
(12) Patent Application Publication
(10) Pub. No.: US 2020/0366879 A1
(43) Pub. Date: Nov. 19, 2020

(54) THREE-DIMENSIONAL IMAGE FORMATION SYSTEM

(71) Applicants: Claudia ARNOLD, London (GB); Nicholas HOOTON, London (GB); Lewis HORNBY, London (GB); Royal College of Art, London (GB)

(72) Inventors: Claudia Arnold, London (GB); Nicholas Hooton, London (GB); Lewis HORNBY, London (GB)

(21) Appl. No.: 16/963,321

(22) PCT Filed: Jan. 18, 2019
(86) PCT No.: PCT/GB2019/050151

§ 371 Date: Jul. 20, 2020

(30) Foreign Application Priority Data
Jan. 18, 2018 (GB) 1800831.8

(51) Int. Cl. H04N 13/189; G06T 17/10; G03B 21/608; G06T 7/557; G06Q 30/02

(52) U.S. Cl. CPC H04N 13/189; G06T 17/10; G06Q 30/0242; G06T 7/557; G03B 21/608

(57) ABSTRACT

A three-dimensional image formation system 1000, 1500 comprises a display 1080, 1580 configured to provide or display an image, and a scattering medium producing device 1085, 1585 configured to produce a light scattering medium. The display is configured to be viewed through a said scattering medium to create a three-dimensional image. The system is configured such that a thickness of the scattering medium through which the display is viewable is variable with respect to a viewing angle.

### TECHNICAL FIELD

The present invention relates to a three-dimensional image formation system and, in particular, to a three-dimensional image formation system that utilises scattering of light.

### BACKGROUND

Many image formation and display devices are known including, for example LCD or LED screens. Electronic advertising has become more popular. Such screens, which can be quite large or small depending on the use, are visible in many cities around the world. A reason that these are popular is that a moving image is more engaging to a potential consumer/user than a static image. Moving images also permit the advertising material/content to be changed easily and frequently.

However, a downside is that operating electronic advertising costs money and takes up space where it is installed, e.g. in the street. However, advertising also generates money. It would be beneficial to maximise the usefulness of electronic advertising. The present invention seeks to come up with a new and innovative image formation system—for advertising or otherwise—and has been developed with the foregoing in mind.

The present invention has been devised with the foregoing in mind.

### SUMMARY

According to a first aspect of the invention, a three-dimensional image formation system comprises a display and a scattering medium producing device configured to produce a light scattering medium. The display may be configured to provide or display light or an image, e.g. a two-dimensional image, and may also be configured to be viewed through the scattering medium to create a different e.g. a “floating” and/or three-dimensional image. The system may be configured such that a thickness of the scattering medium through which the display is viewable is variable with respect to a viewing angle.

An advantage of the above described system is the simple production of a three-dimensional visual effect from a two-dimensional image. This effect is achieved simply using a scattering medium placed in front of the display. Light from the display is scattered through different thicknesses of scattering medium dependent upon a viewing angle. When a viewer then views the display, views of the image displayed on the display produced from different viewing angles are merged to produce a three-dimensional and/or holographic effect to the user. This aspect of the invention therefore provides a simpler alternative for rendering three-dimensional images and/or image effects from two-dimensional images displayed on a display.

According to a second aspect of the invention, an image formation system comprises a display and a scattering medium producing device configured to produce a light scattering medium. The display may be configured to display light or an image e.g. a two-dimensional image. The system may be configured such that scattering medium is located behind the display. The scattering medium may be of variable thickness with respect to the viewing angle. The display may be partially or fully transparent such that the scattering medium is viewable through the display.

The following optional features are equally applicable to either of the two aspects of the invention described above.

In an embodiment, the scattering medium producing device may be configured to produce a mist of fluid droplets. An advantage of this is that a low cost consumable material is utilised to produce a complex visual effect (by rendering a three-dimensional image from a two-dimensional image displayed on a display using light scattered by the fluid droplets). In an embodiment, the system may comprise one or more fluid outlets configured to produce the mist of fluid droplets. Fluid droplets produced by the scattering medium producing device may also be used to trap pollutant particles in the air surrounding the system. Those polluted fluid droplets can then be removed and treated, providing an environmental benefit.

In an embodiment, the one or more fluid outlets may be configured to vary a fluid droplet size of the mist or spray of fluid droplets. An advantage of this is that because light scattering is highly dependent on particle size, the characteristics of the light scattering caused by the fluid droplets can be optimised to produce an array of visual effects. For example, the scattering intensity may be varied by varying fluid droplet size, so the intensity of the three-dimensional image can be tailored. Fluid droplets of different sizes could be produced at different locations relative to the display in order to increase the intensity of light scattering of particular regions of an image. Varying the fluid droplet size may also allow for optimisation of a collection efficiency with regard to removing pollutant particles from the air surrounding the system. Particular sizes of pollutant particles may be more likely interact, collide and combine with fluid droplets of specific sizes. By being able to vary the fluid droplet size, the system can react in real time to changing air quality conditions and effectively capture air pollutant particles using the fluid droplets.

The fluid droplet size may be varied by using one or more outlets e.g. a sprayer or nozzle, or an array of sprayers or nozzles. The pressure of fluid e.g. air and/or water can be varied to create sprays with different diameter droplets. The air/water pressure may be variable in real time, e.g. depending on measured local pollution levels. The droplet size may also be adjusted by adjusting the sprayer nozzle aperture size and/or shape. Where the outlet is an ultrasonic atomisers, the droplet size may be adjusted by changing its frequency.

In an embodiment, the system may comprise a hollow structure comprising an air inlet and an air outlet. In such an embodiment, utilising air flow to move the fluid droplets may work synergistically with the light scattering produced by the fluid droplets in order to produce dynamic visual effects (e.g. such that images appear to be moving in space, and are not fixed to a particular display region defined by the display dimensions). Utilising a hollow structure with an air inlet and an air outlet may also allow targeted volumes of air to be treated in order to remove pollutant particles. The cleaned air can then be returned to the external environment.

In an embodiment, the hollow structure may be a hollow columnar structure. An advantage of this feature is that a collection efficiency of pollutant particle removal can be maximised by maximising the distance between the air inlet and the air outlet. This is most easily achieved by using taller or longer structures like hollow columnar structures.

In an embodiment, the hollow columnar structure may have an open end. The air inlet or air outlet of the hollow columnar structure may be formed by or provided at the open end. In an embodiment, the air inlet or outlet may be located proximate the open end.

In an embodiment, the system may further comprise an aperture in the hollow structure, wherein the air outlet or air inlet is formed or provided by the aperture.

In an embodiment, the system may further comprise a fan configured to assist air flow from the air inlet to the air outlet. An advantage of this feature is that dynamic visual effects produced by moving fluid droplets suspended in the air flow may be enhanced. Increasing a throughput of air through the system also allows for a greater volume of polluted air to be treated.

In an embodiment, the system may further comprise a secondary fluid outlet configured to flow across an internal surface of the hollow structure in a direction substantially corresponding to the direction of air flow from the air inlet to the air outlet. An advantage of this feature is that the flow of fluid from the secondary fluid outlet keeps the internal surface of the hollow structure clean and clear, maximising transmission of light scattered by the scattering medium to a viewer. The flow of fluid also produced an entraining effect by creating a drag force on surrounding air, creating an air flow which encourages and enhances the flow of air through the system. This acts to increase the throughput of air to be treated. The increased air flow resulting from the fluid flow of the secondary fluid outlet may also provide enhanced dynamic visual effects.

In an embodiment, a portion of the hollow structure may form a fluid reservoir, and the air outlet or air inlet may be located above a level of a fluid in the fluid reservoir. An advantage of this feature is that an external fluid source such as mains water supply is not required to use the system. The system is therefore self-contained. Locating the air outlet or air inlet above the level of the fluid in the fluid reservoir prevents the need for further sealing protection in order to prevent leakage from the fluid reservoir.

In an embodiment, the system may further comprise a fluid pump configured to pump clean or treated fluid from the fluid reservoir to the fluid outlets and/or the secondary fluid outlet. An advantage of this feature is that a constant source of clean fluid is not required in order to use the system for extended periods of time. Fluid droplets output by the fluid outlets and/or the secondary fluid outlet may be collected in the reservoir and recirculated to the system.

In an embodiment, one or more of the fluid outlets may comprise an ultrasonic atomiser, and optionally or preferably may further comprise a variable nozzle sprayer. An advantage of this feature is that ultrasonic atomisers are an energy efficient method of producing a fine mist of fluid droplets, which is dense enough to fall under gravity. The fine mist of fluid droplets falling under gravity allows a greater surface area for the fluid droplets to interact with or collide with and attract pollutant particles in the air, allowing for greater removal efficiency of pollutant particles from the air. The downwards motion of the fine mist of fluid droplets produced by the ultrasonic atomisers falling under gravity also encourages and enhances the airflow moving from the air inlet to the outlet. This may also provide a synergistic effect along with the fan and the moving fluid provided by the secondary fluid outlet described with respect to previous embodiments. This may also enhance the dynamic visual effects caused by the movement of fluid droplets whilst scattering light from the image displayed on the display.

In an embodiment, one or more of the fluid outlets may be located in a fluid bath and configured to produce a spray of fluid droplets using fluid in the fluid bath. The system may be further configured to maintain the level of the fluid in the fluid bath at a constant level. An advantage of this feature is that the ultrasonic atomisers may be submerged in the fluid contained in the fluid bath. The depth of submersion of the ultrasonic atomisers varies the number of droplets produced by the ultrasonic atomisers. This may allow the system to vary the characteristics of the three-dimensional image produced by varying the intensity of the scattered light (a greater number of fluid droplets may increase light scattering by varying degrees at varying viewing angles). This may allow the system to enhance or reduce the apparent intensity of particular regions of the three-dimensional image produced.

In an embodiment, one or more fluid outlets and/or the secondary fluid outlet and/or the fluid baths may be provided on a support. This feature acts to increase ease of installation of the system by simply locating a single support within the hollow structure, with the necessary features (i.e. the one or more fluid outlets and/or the secondary fluid outlet and/or the fluid baths) already pre-installed on the support. The support may be located centrally in the hollow chamber. The support may also comprise a hollow internal space configured to contain the electrical wiring and fluid piping required to provide power and fluid to the one or more fluid outlets and/or the secondary fluid outlet and/or the fluid baths.

In an embodiment, the system may further comprise a fluid cleaning device located in the fluid reservoir. The fluid cleaning device may be a UV light cleaning device, or a mechanical filtering device, or a chemical-based cleaning device (e.g. chlorine). An advantage of this is that fluid in the fluid reservoir may be cleaned before being recirculated through the system. This may enable the system to reuse the same fluid without any loss in quality of the rendered three-dimensional image viewable by a viewer, or any loss in collection efficiency of removing pollutant particles from the air within the system.

In an embodiment, the system may further comprise a polluted fluid chamber configured to store fluid which has been output from the one or more fluid outlets and/or the secondary fluid outlet separately from fluid in the fluid reservoir. An advantage of this feature is that there is a much reduced risk of contamination of clean fluid by fluid that contains pollutant particles in systems where there is no fluid cleaning device. This allows the quality of both the rendered three-dimensional image produced by the system, and the collection efficiency of removal of pollutant particles from the air flowing through the system, to be maintained.

In an embodiment, the air inlet may be configured to assist air entering the structure. The air inlet may also, or alternatively, have curved or rounded edges. An advantage of this is that air inlets comprising this feature utilise the Venturi effect. This effectively magnifies the air flow to increase the throughput of air and increase the operating efficiency of the system in terms of pollutant particle removal.

In an embodiment, the display may be a display screen e.g. a flat display screen, or may be a curved display screen.

In an embodiment, the scattering medium producing device may be located behind the display screen relative to a viewpoint of a viewer.

In an embodiment the display may be partially or fully transparent.

According to a third aspect of the invention, an air pollution treatment system comprises a hollow structure comprising an air inlet and an air outlet. The system may comprise one or more fluid outlets configured to produce a spray of fluid droplets. The system may be configured to vary a fluid droplet size of the spray of fluid droplets. The system may take in air through the air inlet. It may be configured such that pollutants in the air attach to the fluid droplets. The polluted fluid droplets may be directed to the fluid reservoir. The “cleaned” air may be exhausted from the air outlet. The system may be used outside, e.g. in urban environments.

An advantage of the air pollution treatment system being configured to produce variable fluid droplet size is that the system can be configured to respond to changing conditions in air quality (e.g. type of pollutant, concentration of pollutant, size of pollutant particle). The fluid droplet size can be optimised to address changes in air quality (e.g. remove varying sizes of pollutant particles and/or different types of pollutant particles) from the air in real-time.

This system mimics and enhances the natural process provided by rainwater droplets colliding with pollutant particles in the air. Here, rainwater droplets attract, collide with and then combine with pollutant particles in the air during travel.

In an embodiment, the hollow structure may be or comprise a hollow columnar or tubular structure. The hollow structure may be a double walled tubular structure. The spray of treatment fluid droplets may be produced between the tubular walls. All or part of the walls may be uniformly spaced from each other. The walls may be non-uniformly spaced to accommodate components of the system and/or to vary the amount of spray/mist that can be housed between the walls.

An advantage of this feature is that columnar or tubular structures typically provide a high aspect ratio (in that the length is much greater than the width). The collection efficiency of removing pollutant particles from the air is increased by increasing the distance between the air inlet and the air outlet. It is also desirable to minimise the floor space which the system requires. Both of these features of the system can be optimised by using hollow columnar structures with a high aspect ratio. However, for a structure of any shape or design, collection efficiency can be optimised by increasing the distance between the air inlet and the air outlet.

In an embodiment, an end of the hollow columnar or tubular structure may be open and configured to act as the air inlet or air outlet. In the above-described embodiment, the space between the double tubular walls is open at an end.

By placing the air inlet or air outlet at an end of the hollow columnar structure, the distance between the air inlet and the air outlet may be maximised, increasing the collection efficiency of removing pollutant particles from the air passing through the system.

In an embodiment, a portion of the hollow structure may be configured to act as a fluid reservoir. An advantage of this feature is that the system can be self-contained, and minimise its footprint area. This may be synergistic with the increased collection efficiency produced by using a hollow columnar structure with a high aspect ratio (to minimise the floor space required for the system whilst maximising the distance between the air inlet and the air outlet to increase collection efficiency).

In an embodiment, the hollow structure may further comprise an aperture in the hollow structure configured to act as the air outlet or air inlet. The aperture may be located above the level of a fluid in the fluid reservoir. An advantage of this feature is that as the fluid reservoir is contained within a portion of the hollow structure, locating the air outlet or air inlet as an aperture above the fluid level of the fluid reservoir allows for the system to maximise the distance between the air inlet and the air outlet whilst easily containing the fluid in the fluid reservoir without the need for any sealing requirements preventing leakage.

In an embodiment, the system may further comprise a fan configured to assist air flow from the air inlet to the air outlet. An advantage of this feature is that the fan may enhance air intake into the system and also enhance expulsion of air back into the external environment. This allows a higher throughput of air through the system resulting in the removal of pollutants from a greater volume of air, thereby increasing efficiency of removal of pollutant particles from the air.

In an embodiment, the system may further comprise a secondary fluid outlet configured to cover an internal surface of the hollow structure in fluid such that the fluid from the secondary fluid outlet flows across the internal surface of the hollow structure in a direction substantially corresponding to the direction of air flow from the air inlet to the air outlet. An advantage of this feature is that a moving flow of fluid creates a drag on the surrounding air, which causes an air flow in the direction of the moving fluid flow. This effect is synergistic with the air flowing through the system naturally, and may also be synergistic with a fan used to enhance airflow through the system, resulting in greater entrainment of air into the system.

A higher volumetric flow of polluted air through the system enables a greater volume of air to be treated, thereby increasing efficiency of removal of pollutant particles from the air.

In an embodiment, the system may further comprise a fluid pump configured to pump fluid (e.g. clean or treated fluid) from the fluid reservoir to each of the one or more fluid outlets and/or the secondary fluid outlet. An advantage of this feature is that delivery of fluid to the one or more fluid outlets and/or the secondary fluid outlet may be improved, enabling the one or more fluid outlets and/or the secondary fluid outlet to operate in optimum conditions. This may maximise the efficiency of the one or more fluid outlets and/or the second fluid outlet resulting in improved operation of the system as a whole, thereby increasing efficiency of removal of pollutant particles from the air. Alternatively, the system may further comprise a fluid pump configured to deliver fluid from a mains water supply to the fluid outlets and/or the secondary fluid outlet

In an embodiment, an or each fluid outlet may comprise an atomiser, e.g. an ultrasonic atomiser. An or each fluid outlet may comprise a variable sprayer e.g. a variable nozzle sprayer. An advantage of this feature is that ultrasonic atomisers are an energy efficient method of producing a fine mist of fluid droplets, which is dense enough to fall under gravity. The fine mist of fluid droplets falling under gravity allows a greater surface area for the fluid droplets to interact with or collide with and attract pollutant particles in the air, allowing for greater removal efficiency of pollutant particles from the air. The downwards motion of the fine mist of fluid droplets produced by the ultrasonic atomisers falling under gravity also encourages and enhances the airflow moving from the air inlet to the outlet. This may also provide a synergistic effect along with the fan and the moving fluid provided by the secondary fluid outlet described with respect to previous embodiments.

In an embodiment, one or more or the fluid outlets may be located in a fluid bath, and may be configured to produce a spray of fluid droplets using fluid contained in the fluid bath. The system may also be configured to maintain the level of the fluid in the fluid bath at a constant level. An advantage of this feature is that the ultrasonic atomisers may be submerged in the fluid in the fluid baths at an optimum depth to produce an optimum number of fluid droplets required for optimum pollutant particle removal efficiency. A frequency of the ultrasonic atomisers may be varied to vary the fluid droplet size produced by the fluid outlets. The level at which the fluid in the fluid baths is kept constant, and the frequency of the ultrasonic atomisers, may both be varied in real-time based on the pollutant particle size and the pollutant particle concentration present in the air flowing through the system.

In an embodiment, the system may further comprise a fluid cleaning device located in the fluid reservoir. An advantage of this feature is that a constant supply of clean fluid for removing pollutant particles from the air flowing through the system, such as from a mains water supply or other external fluid source, is not required. Instead, fluid provided to the one or more fluid outlets and/or the secondary fluid outlet may return to the fluid reservoir containing pollutant particles. The pollutant particles may then be removed from the fluid in the fluid reservoir by passing through the fluid cleaning device located in the fluid reservoir. The cleaned fluid (with pollutant particles removed) can then be recirculated to the one or more fluid outlets and/or the secondary fluid outlet so that efficiency of the pollutant particle removal from the airflow is maintained. If the pollutant particles contained in the fluid droplets returning to the fluid reservoir after being output by the one or more fluid outlets and/or the secondary fluid outlet are not removed, then the removal efficiency of the system decreases. This is because if the fluid droplets output by the one or more fluid outlets already contain pollutant particles, those fluid droplets are much less likely to collide with and attract pollutant particles from the air flow as those fluid droplets may already be saturated with pollutant particle matter.

In an embodiment, the system may further comprise a polluted fluid chamber configured to store (polluted) fluid which has been output from the one or more fluid outlets and/or the secondary fluid outlet separately from fluid in the fluid reservoir. An advantage of this feature is that there is no possibility that fluid droplets containing pollutant particles can contaminate the fluid in the fluid reservoir. If fluid droplets provided to the one or more fluid outlets and/or the secondary fluid outlet from the fluid reservoir already containing pollutant particles, this may reduce their ability to collide with and attract pollutant particles from the air flowing through the system. By providing a separate polluted fluid chamber for fluid that has already been provided to the one or more fluid outlets and/or the secondary fluid outlet, this risk is eliminated. Fluid that has been treated or cleaned may be recycled and reused by being supplied back to the one or more fluid outlets and/or the secondary fluid outlet; any fluid that has not been cleaned may be retained in the polluted fluid chamber.

In an embodiment, the air inlet is configured to assist air entering the structure. The air inlet may be configured to utilise the Venturi effect to encourage, magnify and/or enhance entrainment of air into the air inlet 820. To achieve this, the air inlet may have rounded or curved edges.

In an embodiment, the system may further comprise a support, wherein the one or more fluid outlets and/or the secondary fluid outlet and/or the fluid baths are provided on the support. An advantage of this feature is that a single support configured to support the features of the system increases the available space within the hollow structure for fluid droplets to interact with pollutant particles in the air flowing through the system. This feature also acts to increase ease of installation of the system 100 by simply locating a single support within the hollow structure, with the necessary features (i.e. the one or more fluid outlets and/or the secondary fluid outlet and/or the fluid baths) already pre-installed on the support. The support may be located centrally in the hollow chamber. The support may also comprise a hollow internal space configured to contain the electrical wiring and fluid piping required to provide power and fluid to the one or more fluid outlets and/or the secondary fluid outlet and/or the fluid baths. The synergistic effect of providing features of the system on a support, and also containing the necessary utilities for the features of the system within the core of the support is to increase the available space for fluid droplets to interact with pollutant particles in the air, thereby increasing the collection efficiency of pollutant particle removal.

According to an embodiment or a fourth aspect of the invention, a three-dimensional image formation system is provided. The system comprises a display e.g. a display screen e.g. configured to display a two-dimensional image. The system may further comprise a scattering medium producing device configured to produce a light scattering medium. The display screen may be configured to be viewed through a said scattering medium that has been produced by the scattering medium producing portion. The system may be configured such that a thickness of the scattering medium through which the display screen is configured to be viewed is variable with respect to a viewing angle.

Typically imaging and display devices project an image, either two-dimensional or three-dimensional, onto a scattering medium. In this case, an image displayed on a display screen is being viewed through a thickness of scattering medium, in order to alter the viewer's perception of the image from that of a two-dimensional image to a three-dimensional image. This effect is achieved simply using a scattering medium placed in front of the display screen. When a viewer then views the display screen, views of the image displayed on the display screen produced from different viewing angles are merged to produce a three-dimensional and/or holographic effect to the user. This aspect of the invention therefore provides a simpler alternative for rendering three-dimensional images and/or image effects from two-dimensional images displayed on a screen.

In an embodiment, the display screen may be a flat display screen, or may be a curved display screen.

In an embodiment, the scattering medium may be a mist of fluid droplets.

In an embodiment, the three-dimensional image formation system of any aspect may further comprise the air pollution treatment system of any of the embodiments of the third aspect of the invention. The three-dimensional image formation system may be contained within the hollow structure according to the above embodiment(s). The scattering medium producing device may be the one or more fluid outlets according to the first aspect of the invention.

The advantage of this combination is that a combined air pollution treatment and display system may be achieved. This could have positive implications for generating revenue from an environmentally beneficial technology, by displaying advertising on the display screen whilst simultaneously removing pollutant particles from the air flowing through the system.

In an embodiment, the display screen may be supported on the support according to the embodiment described above. The advantages of this feature are two-fold. The space available for fluid droplets interacting with pollutant particles in the air flowing through the system is maximised, while the utilities for supplying power and fluid to the display screen and one or more fluid outlets are contained within an internal space of the support, providing protection and ease of maintenance for the system as whole and for individual parts. Containing the utilities within an internal space of the support also helps to maximise space for removing pollutant particles from the air flowing through the system. Alternatively different supports could be used.

In an embodiment, the scattering medium producing device may be located behind the display screen relative to a viewpoint of a viewer. The advantage of this is that no part of the image displayed on the display screen may be obscured by the scattering medium producing device. A further advantage is that the three-dimensional imaging effect caused by the scattering of light from the image passing through the scattering medium is not affected by the presence of any other objects potentially in the path of the scattered light.

Features which are described in the context of separate aspects and/or embodiments of the invention may be used together and/or be interchangable. Similarly, where features are, for brevity, described in the context of a single embodiment, these may also be provided separately or in any suitable sub-combination. Features described in connection with a device, system or apparatus may have corresponding features definable with respect to a method and these embodiments are specifically envisaged.

### BRIEF DESCRIPTION OF THE DRAWINGS

The invention will now be described by way of example with reference to the accompanying drawings in which:

FIG. 1 shows an embodiment of an air pollution treatment system;

FIG. 2 shows an embodiment of an air pollution treatment system further comprising a fan to assist air flow through the system;

FIG. 3 shows an embodiment of an air pollution treatment system further comprising a secondary fluid outlet;

FIG. 4 shows an embodiment of an air pollution treatment system further comprising a fluid pump;

FIG. 5 shows a fluid bath in accordance with an embodiment of an air pollution treatment system;

FIG. 6 shows an embodiment of an air pollution treatment system further comprising a fluid cleaning device;

FIG. 7 shows an embodiment of an air pollution treatment system further comprising a polluted fluid chamber;

FIG. 8 shows an embodiment of an air pollution treatment system further comprising a hollow columnar structure with rounded edges;

FIG. 9 shows an embodiment of an air pollution treatment system further comprising a support; and

FIG. 10 shows an embodiment of a three-dimensional image formation system; and

FIG. 11 shows an embodiment of a three-dimensional image formation system comprising a double walled structure; and

FIG. 12 shows an embodiment of a three-dimensional image formation system; and

FIG. 13 shows an alternative embodiment of a three-dimensional image formation system; and

FIG. 14 shows an annotated portion of the system of FIG. 13;

FIG. 15 shows an embodiment of an alternative three-dimensional image formation system; and

FIG. 16 shows a front view of the image formation system of FIG. 15.

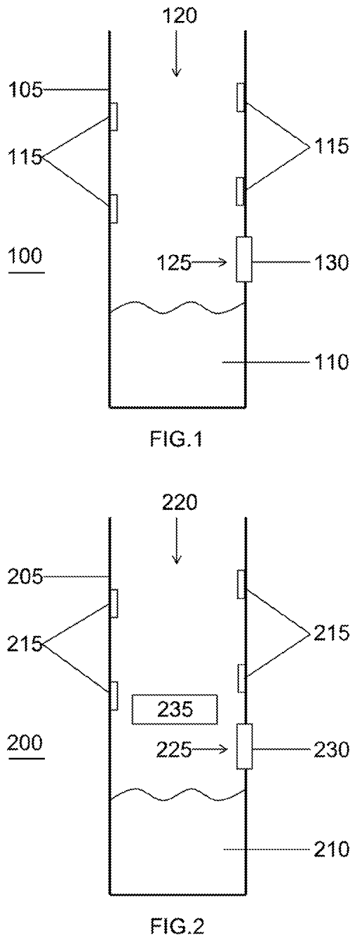

Like reference numbers and designations in the various drawings indicate like elements. For example, feature 105 in FIG. 1 of the drawings corresponds to feature 205 in FIG. 2 of the drawings, and so on. Where a full description for a feature is not given for a particular embodiment, it can be taken to be the same as or equivalent to the feature with a like number and designations provided for an earlier embodiment.

Features which are described in the context of separate aspects and embodiments of the invention may be used together and/or be interchangeable wherever possible. Similarly, where features are, for brevity, described in the context of a single embodiment, these may also be provided separately or in any suitable sub-combination. In particular, the air pollution treatment system and the three-dimensional image formation system may be separate aspects or may be part of the same aspect. Features described with reference to one aspect may additionally/instead be utilised in one or more other aspects.

### DETAILED DESCRIPTION

Aspects and embodiments of the invention provide a novel way to display images e.g. advertising that can be used, for example, to monetise reduction of air pollution.

Air pollution is the single largest cause of death in the world, with 5.5 million deaths attributable to air pollution worldwide annually. In London, pollution levels are twice the legal limit, which has been attributed to 10,000 premature deaths in the city each year. Nationwide in the UK, health problems caused by air pollution cost the National Health System (NHS) £20 billion annually.

Typically, attempts to deal with pollution have focussed on tackling pollution at source. However, the sources of pollution are varied and diffuse, meaning that tackling any single one of these sources has a very limited impact and involves thousands of stakeholders. Current systems put in place to deal with individual pollutants at source are inherently specific to the pollutant and the conditions in which the pollutant is produced.

It is perhaps unsurprising therefore that pollution levels are set to double by 2050. One contributor to this is that electric cars produce more of the most harmful pollutants than petrol vehicles, as particulate emissions from brakes and tires of electric cars are higher than those for petrol vehicles due to their heavier weight (relative to petrol vehicles).

The size of particulate matter is inversely proportional to the hazard it poses to humans. There has been a large amount of research into this phenomenon. For example, PM10 particulates (2.5 to 10 μm in diameter) are caught in the throat, whereas smaller PM2.5 particulates (2.5 μm or smaller in diameter) are caught in the lungs, and can cause more harm. However, PM1.0 particulates (1 μm or smaller in diameter) and smaller, including nanoparticulates and ultrafine particles (UFPs) are absorbed directly into the bloodstream. The increased danger of these smaller particles is only recently starting to become acknowledged.

FIG. 1 shows an air pollution treatment system 100. The system 100 comprises a hollow structure 105, a fluid reservoir 110, and one or more fluid outlets 115 configured to produce a spray of fluid droplets and configured to vary a fluid droplet size of the spray of fluid droplets. The hollow structure further comprises an air inlet 120 and an air outlet 125. The system 100 draws in surrounding air to the hollow structure 105 through the air inlet 120. Once the air is within the hollow structure 105, pollutant particles contained within the air are attracted to, collide with and become attached to or combined with fluid droplets produced by the one or more fluid outlets 115, wherein fluid is provided to the one or more fluid outlets 115. The air outlet 125 further comprises a filter 130 configured to remove fluid droplets containing pollutant particles from air passing through the air outlet 125. Air leaving the air outlet 125 is expelled to the atmosphere.

Attaching the pollutant particles to larger fluid droplets before passing the air flow through the filter 130 of the air outlet 125 enables a much higher throughput of air when compared to traditional HVAC system. A traditional HVAC system which simply filters air drawn in through an air inlet requires a series of dense filters in order to remove pollutant or contaminant particles. By combining the pollutant particles with fluid droplets in the hollow structure 100 before passing the air flow through the air outlet 125, the density of the filter 130 used in the air outlet 125 can be much less dense in comparison to a traditional HVAC system whilst still effectively and efficiently removing pollutant particles. The lower density of the filter 130 enables an increased throughput of air (and requires less energy to achieve an increased throughput of air) when compared to a traditional HVAC system.

The pollutant particle removal efficiency of traditional wet scrubbing systems is dependent on the size of the fluid droplets in comparison to the pollutant particles the system is intended to capture and remove. Traditional wet scrubbing systems deal with pollutant particles at source, and so are optimised to deal with only a very specific type and size of pollutant particle.

The one or more fluid outlets 115 being configured to vary the fluid droplet size of the spray of fluid droplets therefore also provides further advantages when compared to traditional HVAC or industrial wet scrubbing systems. In being configured to vary the fluid droplet size produced by the one or more fluid outlets 115, the system 100 is able to optimise the size of the fluid droplets in order to efficiently capture and remove different sizes of pollutant particles from the air as and when the size of the pollutant particles passing through the system 100 changes. In this way, the system 100 is able to respond to changing conditions in local air quality in real-time.

In the embodiment shown, the hollow structure 100 is a hollow columnar structure. In alternative embodiments, the hollow structure may be any hollow shape with an air inlet 120 and an air outlet 125.

In the embodiment shown, the hollow columnar structure has a substantially circular cross-sectional profile. In alternative embodiments, the hollow columnar structure may have a cross-sectional profile of any shape, for example triangular, square, pentagonal etc. In the embodiment shown, an end of the hollow columnar structure is open and configured to act as the air inlet 120. In alternative embodiments, the air inlet 120 may be located at any position on the hollow structure 105.

In the embodiment shown, one or more fluid outlets 115 are each mounted on and connected directly to the inner surface of the walls of the hollow structure 105. The fluid outlets 115 may be connected by a fastener (e.g. a bolt or a screw) to the inner surface of the walls of the hollow structure 105. In alternative embodiments, the fluid outlets 115 may be connected to the inner surface by any suitable attachment mechanism, for example permanent or removable adhesives, or by engagement of corresponding features located on the inner surface and the fluid outlets 115 respectively (e.g. a tongue and groove connection).

In the embodiment shown, the one or more fluid outlets 115 are spaced apart evenly in a radial direction around the circumference of the hollow structure 105, and also spaced apart evenly in an axial direction along the axial length of the hollow structure 105. In alternative embodiments, the one or more fluid outlets 115 may be spaced in clusters or groups at specific locations within the hollow structure 105, depending on the requirements of the system 100. In alternative embodiments, the one or more fluid outlets 115 may be mounted on a separate support. The support may be connected to the walls of the hollow structure 105, or may be freestanding within the volume enclosed by the hollow structure 105.

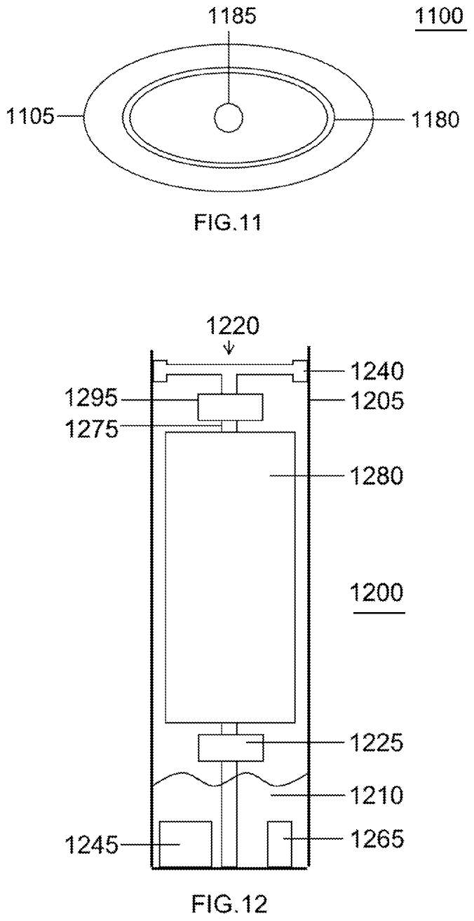

In a particular embodiment, the hollow structure is a double walled structure, defining a space between the walls in which the spray of fluid droplets is produced, e.g. as shown in FIG. 10 or 11 (discussed later). In such embodiments, the fluid outlets 115 are most conveniently located between the two walls. In such embodiments, the fluid outlets 115 may be mounted on the inner surface of the outer wall of the double walled structure, or may be mounted on the outer surface of the inner wall of the double walled structure. The fluid outlets 115 may be mounted by the same mechanisms as discussed with respect to a single walled embodiment (i.e. a bolt or a screw, temporary or permanent adhesive, or engagement of corresponding features).

In the embodiment shown, a portion of the hollow structure 105 is configured to act as the fluid reservoir 110. In alternative embodiments, the fluid reservoir 110 may be separate from the hollow structure 105, and may be located internally of or externally to the hollow structure 105. In alternative embodiments, the system 100 may not comprise a fluid reservoir. Additionally or instead it may comprise a mains fluid inlet and a mains fluid outlet connected to a mains water supply.

In the embodiment shown, an aperture in the hollow structure 105 is configured to act as the air outlet 125. The aperture is located above the level of the fluid in the fluid reservoir 110. In alternative embodiments, the fluid reservoir 110 may be separate from the hollow structure 105, or the system 100 may not comprise a fluid reservoir and may instead comprise a mains fluid inlet and a mains fluid outlet connected to a mains water supply. In either of these alternative embodiments, the air outlet 125 may be located at any position on the hollow structure 105.

The collection efficiency (efficiency of removing pollutant particles from the air) is increased by increasing the distance between the air inlet 120 and the air outlet 125. Therefore, in the embodiment shown, air is drawn in through the air inlet 120, located at the top of the hollow structure 105, and is expelled through the air outlet 125, located near the base of the hollow structure 105 in order to utilise as much of the length of the hollow structure 105 as possible. However, in alternative embodiments, the air inlet 120 and the air outlet 125 may have their locations reversed and/or not be located as far apart as possible, and may be located nearer to each other depending on design constraints.

In the embodiment shown, the filter 130 is a demisting mesh. In alternative embodiments, a condenser arrangement may be used instead of, or in addition to, a demisting mesh.

In the embodiment shown, the system 100 is a stand-alone static system requiring only a power source in order to function. The system 100 stands directly on the ground. In alternative embodiments, the system may be mobile, and/or may be raised up and supported by a static or mobile platform. The mobile platform may have wheels in order to facilitate movement of the system. In alternative embodiments, the system may be modular. In a modular system, multiple systems 100 may be stackable on top of one another, or connectable in series, or configured to connect side by side, in order to create new forms of the system 100. These new forms may provide increased benefits with regard to collection efficiency of the system 100.

In alternative embodiments, the system 100 may be quickly implemented into urban environments by making use of disused telephone boxes, lamp posts, electric vehicle charging points etc. The system 100 can be located on any urban furniture which can supply the system 100 with a power source.

The system 100 can be located in pollution hotspots where the concentration of pollutant particles is high, for example in areas of slow moving traffic. The system 100 can also be located inside buildings to tackle indoor air pollution. For example, the system 100 can be located in shop windows, hotel lobbies, shopping centres, hospitals, schools, within both existing and new city infrastructures and architecture (e.g. cladding, walls and bridges). The system can also be fitted to large mobile structures, vehicles and other methods of transport.

A plurality of systems can be implemented in a distributed network across an indoor or outdoor environment.

In alternative embodiments, the system may also comprise a centrifugal separator configured to separate fluid droplets from air passing through the air outlet 125. The centrifugal force acting on the fluid droplets forces the fluid droplets to separate from the air passing through centrifugal separator such that fluid droplets containing pollutant particles can be removed from the air flow. The separated air can then be expelled to the atmosphere.

In alternative embodiments, the system may also comprise a centrifuge. The air passing through the air inlet 120 may be passed through the centrifuge before interacting with fluid droplets within the hollow structure 105. The forces acting on the pollutant particles contained in the air passing through the centrifuge causes smaller pollutant particles to combine into larger, more easily catchable pollutant particles. This increases the efficiency of pollutant particle removal from the air flow using fluid droplets produced by the one or more fluid outlets 115.

FIG. 2 shows an embodiment of an air pollution treatment system 200. The system 200 comprises a fan 235 configured to assist and enhance air flow through the system 200. The fan 235 enhances air intake into the system 200 and expulsion of air back into the external environment. The fan 235 is located near an air outlet 225 to direct and focus the air flow through a filter 230 located in the air outlet 225. This may encourage improved filtering characteristics provided by the filter 230. In alternative embodiments, the fan may be located in any position within a hollow structure 205 of the system 200.

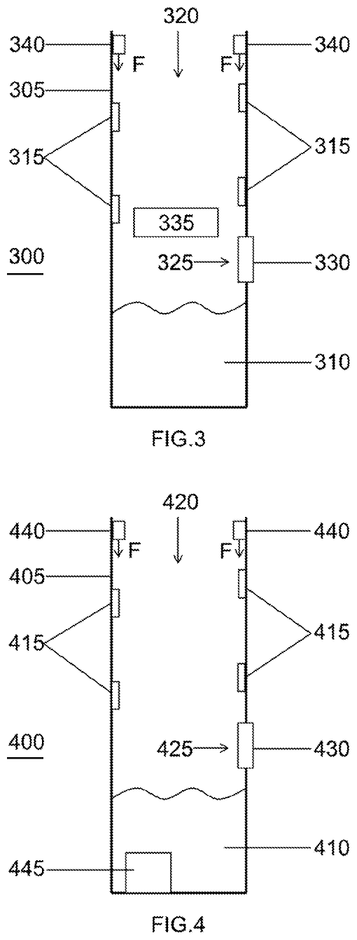

FIG. 3 shows an embodiment of an air pollution treatment system 300. The system 300 comprises a secondary fluid outlet 340 configured to cover an internal surface of a hollow structure 305 in fluid such that the fluid from the secondary fluid outlet 340 flows across the internal surface of the hollow structure 305 in a direction substantially corresponding to the direction of intended air flow from an air inlet 320 to an air outlet 325. The secondary fluid outlet 340 sprays a curtain of fluid down the internal surface of the hollow structure 305, aiding in keeping the internal surface of the hollow structure 305 clean. By keeping the internal surface of the hollow structure 305 clean using the fluid from the secondary fluid outlet 340, it is easy to see through the hollow structure of the system (if the hollow structure is manufactured from a transparent material).

The motion of the fluid flow is depicted by the arrow labelled F in FIG. 3. The motion of the fluid flow creates a drag force on the surrounding air, which causes an air flow through the air inlet 320 of the system 300. The resultant air flow causes an entraining effect which results in increased air flow into the hollow structure 305.

In the embodiment shown, the secondary fluid outlet 340 has a halo shape, i.e. a ring shape. The ring shape of the secondary fluid outlet substantially corresponds to the internal circular cross-sectional shape of the hollow columnar structure 305 of the system 300. In alternative embodiments, the secondary fluid outlet 340 may have a shape which corresponds to the internal cross-sectional shape or profile of the hollow structure 305, e.g. a triangular, square, pentagonal etc.

In the embodiment shown, the secondary fluid outlet 340 is located adjacent to the air inlet 320 in order to maximise the entraining effect of the fluid motion in the hollow structure 305 to draw in air through the air inlet 320. The length of the hollow structure 305 and the speed of entrainment caused by the fluid flow produced by the secondary fluid outlet 340 affect the rate of interactions between the fluid droplets produced by the one or more fluid outlets 315 and the pollutant particles. The faster the fluid flow produced by the secondary fluid outlet 340, the greater the rate of interactions between the fluid droplets produced by the one or more fluid outlets 315 and the pollutant particles.

The secondary fluid outlet 340 may be mounted to the inner surface of the walls of the hollow structure by the same mechanisms as discussed with respect to the fluid outlets 115 (e.g. a bolt or a screw, temporary or permanent adhesive, or engagement of corresponding features). In embodiments comprising a double walled structure, the secondary fluid outlet may be mounted to the inner surface of the outer wall of the double walled structure, or to the outer surface of the inner wall of the double walled structure.

FIG. 4 shows an embodiment of an air pollution treatment system 400. The system 400 comprises a fluid pump 445 configured to pump fluid from a fluid reservoir 410 to each of one or more fluid outlets 415 and/or a secondary fluid outlet 440. In the embodiment shown, the fluid pump 445 is located in the fluid reservoir 410. In alternative embodiments, the fluid pump 445 may be located separately from the fluid reservoir 410, and may be located internally of or externally to a hollow structure 405 of the system 400.

In the embodiment shown, the fluid pump 445 recirculates the fluid around the system 400, wherein fluid that has been sprayed from one or more fluid outlets 415 and/or the secondary fluid outlet 440 collects in the fluid reservoir 410 to be provided once more to each of the one or more fluid outlets 415 and/or the secondary fluid outlet 440.

In alternative embodiments, the fluid from the fluid reservoir 410 may be provided to each of the one or more fluid outlets 415 and/or the secondary fluid outlet 440 by a different mechanism, e.g. the fluid from the fluid reservoir 410 may be gravity fed to each of the one or more fluid outlets 415 and/or the secondary fluid outlet 440. In such embodiments, a separate fluid tank may be provided to collect rainwater, or to collect fluid produced by a dehumidifier. Fluid collected in the separate fluid tank may then be fed to the fluid outlets 415 and/or the secondary fluid outlet 440.

In alternative embodiments, fluid output from the one or more fluid outlets 415 and/or the secondary fluid outlet 440 may not be recirculated through the system 400, but may be stored separately from the fluid in the fluid reservoir 410.

In alternative embodiments, the fluid pump 445 may be connected to a mains water supply, and may be configured to provide fluid from a mains fluid inlet (connected to the mains water supply) to the fluid outlets 415 and/or the secondary fluid outlet 440. Fluid output from the fluid outlets 415 and/or the secondary fluid outlet 440 may then be delivered to a mains fluid outlet to drain back into the mains water system.

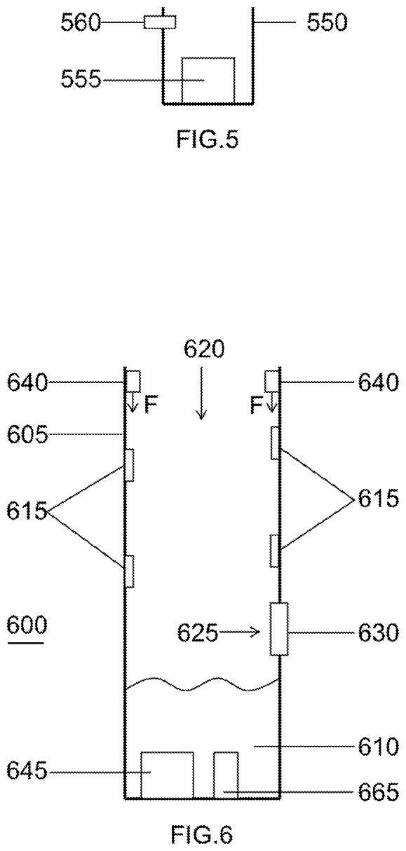

FIG. 5 shows an embodiment of an air pollution treatment system 500. The system 500 comprises one or more fluid outlets 515. In the embodiment shown, each of the one or more fluid outlets 515 comprises one or more ultrasonic atomisers 555. In alternative embodiments, each of the one or more fluid outlets may comprise one or more ultrasonic atomisers and one or more variable nozzle sprayers or jets.

The ultrasonic atomisers 555 of each of the one or more fluid outlets 515 are used to produce a fine mist of fluid droplets. Ultrasonic atomisers are an energy efficient method of producing a fine mist of fluid droplets, and are frequently used in humidifiers, as well as for fog creation in theatrical performance, live music performances and art installations. An advantage of using the ultrasonic atomisers 555 is that the fine mist of fluid droplets produced by the ultrasonic atomisers 555 is dense enough to fall under gravity, rather than rise. The voltage supply to the ultrasonic atomisers 555 can also be varied in order to change the size of the fluid droplets contained in the fine mist produced by the ultrasonic atomisers 555. A variation in the power supplied to a transducer in the ultrasonic atomiser can alter both the rate at which atomisation (i.e. droplet formation) of fluid located on the atomising surface of the transducer occurs, and the droplet size produced during atomisation. Similarly, by altering the frequency of the power/voltage supplied to an atomising surface of the ultrasonic atomisers 555 (i.e. a surface of the transducer on which fluid to be atomised is located), both the rate of atomisation and the droplet size can be accurately controlled. In this way, the size of the fluid droplets produced by the ultrasonic atomisers 555 can be optimised for the collection of different sized of pollutant particle.

In alternative embodiments, an apparatus or system (not shown) configured to monitor the types of pollutant particle in the local environment (e.g. pollutant particle size, pollutant particle concentration, other pollutant particle characteristics) may be incorporated into the system 500. In other alternative embodiments, the monitoring apparatus may be located externally of and separate to the system 500, but may be in electronic or other communication with the system 500. Such embodiments allow the fluid droplet characteristics (e.g. fluid droplet size, fluid droplet number) to be controlled in real-time to adapt to local conditions as and when changes occur. This may enable an increase in collection efficiency for removing pollutant particles from the air flowing through the system 500.

In alternative embodiments, alternative means for producing a fine mist of fluid droplets may be utilised e.g. a pressurised air and fluid system. In such embodiments, varying the air pressure or the water pressure supplied to a nozzle or sprayer may produce sprays with controllably variable fluid droplet diameters. Varying a size and/or a shape of an aperture of the nozzle or sprayer may also enable the production of controllably variable fluid droplet size.

In alternative embodiments, the spray of fluid droplets produced by each of the one or more fluid outlets 515 may be generated by the use of pressurised water and fog (a technique frequently used on construction sites for dust suppression).

In alternative embodiments, the one or more fluid outlets 515 may comprise heat exchange fog machines in order to produce fluid droplets.

In alternative embodiments, the fluid droplets produced by each of the one or more fluid outlets 515 may be electrostatically charged to optimise the efficiency of pollutant particle removal. In alternative embodiments, the fluid droplets produced by each of the one or more fluid outlets 515 may contain a chemical additive to optimise the efficiency of pollutant particle removal.

In alternative embodiments, one or more variable nozzle sprayers or jets of each of the one or more fluid outlets 515 may be used to produce fluid droplets larger than those produced by the ultrasonic atomiser 555 of each of the one or more fluid outlets 515. The one or more variable nozzle sprayers or jets of each of the one or more fluid outlets 515 may be configured to produce sheets of fluid droplets of varying sizes. By producing multiple sizes of fluid droplet using the one or more fluid outlets 515 of the system 500, a range of pollutant particle sizes can be removed from the air flowing through the system 500. In such alternative embodiments, the one or more variable nozzle sprayers or jets may be connected to a separate pressurised fluid system in order to produce fluid droplets (separate from the fluid provided to the ultrasonic atomisers 555 of the fluid outlets 515. The size of the fluid droplets produced by the variable nozzle sprayers or jets may be optimised or varied by varying the fluid pressure or air pressure supplied to the variable nozzle sprayers or jets.

In the embodiment shown, each of the one or more fluid outlets 515 is located in a fluid bath 550, and configured to produce a spray of fluid droplets using fluid contained in the fluid bath 550. A fluid reservoir 510 of the system 500 provides fluid to fill the fluid baths 550 via fluid tracks 560, and the system is configured to maintain the level of the fluid baths 550 at a constant level. The ultrasonic atomisers 555 are submerged in the fluid contained the fluid baths 550, for example at a depth of 10 mm to 30 mm. Maintaining a constant level of fluid in the fluid baths 550 ensures the ultrasonic atomisers 555 are submerged at an optimum depth to produce the correct fluid droplet size for optimum efficiency of pollutant particle removal from the air flow. The level at which the fluid in the fluid baths 550 is kept constant may be varied based on the pollutant particle size present in the air flowing through the system. In alternative embodiments, the depth of the ultrasonic atomisers relative to the surface of the fluid in the fluid baths may be varied whilst the level of fluid in the fluid baths is kept constant. One or more of the fluid baths 550 may be mounted on a wall of the hollow structure, or may be mounted on a support contained within the hollow structure.

In alternative embodiments, fluid from a mains water supply may be provided to fill the fluid baths 550.

In alternative embodiments, the one or more ultrasonic atomisers and/or the one or more variable nozzle sprayers or jets may not be located in a fluid bath.

FIG. 6 shows an embodiment of an air pollution treatment system 600. The system 600 comprises a fluid cleaning device 665 located in a fluid reservoir 610. In the embodiment shown, the fluid cleaning device 665 receives fluid from one or more fluid outlets 615 or a secondary fluid outlet 640, which contains pollutant particles removed from the air flowing through the system 600 and has collected in (returned to) the fluid reservoir 610. The fluid cleaning device 665 removes the pollutant particles from the fluid in the fluid reservoir 610 containing pollutant particles so that the cleaned fluid can be provided to the one or more fluid outlets 615 and/or the secondary fluid outlet 640 once more. In the embodiment shown, the fluid cleaning device 665 is replaceable. In alternative embodiments, the system 600 may not comprise a fluid cleaning device, and the fluid in the fluid reservoir 610 may be removed from the system 600 periodically for cleaning (i.e. to remove pollutant particles from the fluid).

In the embodiment shown, the fluid cleaning device is a mechanical filtering device. In alternative embodiments, the fluid cleaning device may be a UV light cleaning device, or may be a chemical-based cleaning device (e.g. utilising chlorine, similar to swimming pool cleaning chemicals).

In alternative embodiments, fluid may be provided to the system 600, through a mains fluid inlet, using a mains water supply. Once the fluid has been output from the fluid outlets 615 and/or the second fluid outlet 640, the fluid is directed to a mains fluid outlet to be drained back into the mains water system. In such an embodiment, a fluid cleaning device is not required.

In alternative embodiments, the system may not comprise a fluid cleaning device. In such alternative embodiments, a removably replaceable fluid tank may be provided. This allows fluid to be recirculated around the system until it is no longer of sufficient quality to perform pollutant particle removal effectively. At this point, the fluid tank may be removed from the system, the fluid in the fluid tank replaced, and the fluid tank replaced within the system containing fresh fluid to efficiently remove pollutant particles once more.

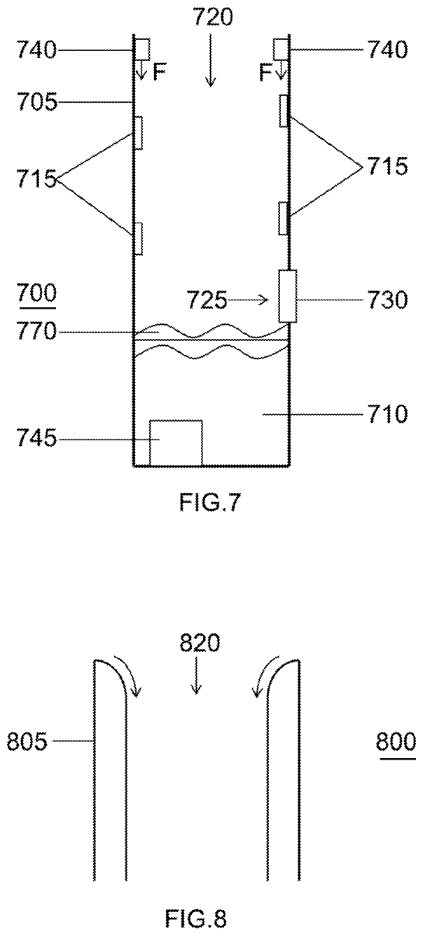

FIG. 7 shows an embodiment of an air pollution treatment system 700. The system 700 comprises a polluted fluid chamber 770 configured to store fluid which has been provided from a fluid reservoir 710 to one or more fluid outlets 715 and/or a secondary fluid outlet 740, and then output from the one or more fluid outlets 715 and/or the secondary fluid outlet 740, the fluid containing pollutant particles removed from the air flowing through the system 700. The polluted fluid chamber 770 is separated from the fluid reservoir 710 such that clean fluid in the fluid reservoir 710 containing no pollutant particles is kept separate from fluid in the polluted fluid chamber 770 containing pollutant particles. In the embodiment shown, fluid that has been output by the one or more fluid outlets 715 and/or the secondary fluid outlet 740 is not recirculated through the system 700. The fluid collected in the polluted fluid chamber 770 is periodically removed from the polluted fluid chamber 770 to be cleaned (i.e. the pollutant particles are removed from the fluid).

In the embodiment shown, the polluted fluid chamber 770 is located within a hollow structure 705 of the system 700. In alternative embodiments, the polluted fluid chamber 770 may be located externally of the hollow structure 705 of the system 700.

FIG. 8 shows an embodiment of an air pollution treatment system 800. The system 800 comprises a hollow structure 805 comprising an air inlet 820. The air inlet 820 has rounded or curved edges which encourage, magnify and enhance entrainment of air into the air inlet 820 in order to utilise the Venturi effect. The Venturi effect is a well-known physical phenomenon used, for example, in aeroplane evacuation slide inflation to increase the speed of inflation. The Venturi effect manifests in a pressure drop resulting from constricting a flow of air (such as through a pipe, or in the embodiment shown through the hollow columnar structure 805). The resultant pressure drop is balanced by an increase in air flow velocity. The Venturi effect achieved by the curved or rounded edges of the air inlet 820 therefore increases the air flow velocity through the system 800, increasing the throughput of air and improving pollutant particle removal efficiency.

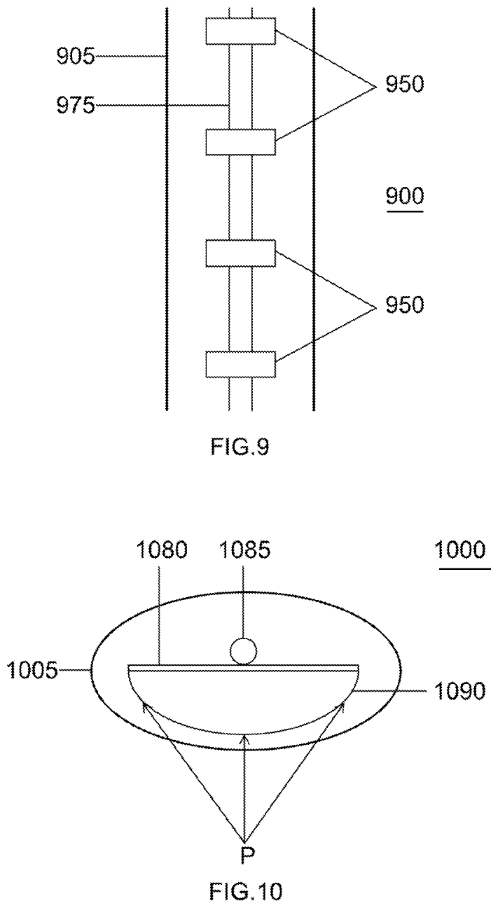

FIG. 9 shows an embodiment of an air pollution treatment system 900. The system 900 comprises a support 975 on which one or more fluid outlets 915, a secondary outlet 940 and one or more fluid baths 950 are supported. In the embodiment shown, the support 975 has an elongate tubular shape. The features supported on the support 975 are spaced periodically along the length of the support 975. In the embodiment shown, the support 975 is located centrally in a hollow structure 905 of the system 900. In alternative embodiments, the support may be located along an internal surface of the hollow structure 905 of the system 900.

In the embodiment shown, the support 975 contains the electronic wiring and the fluid piping for delivering both power and fluid to the various components of the system 900.

In alternative embodiments, the system 900 may be fitted to existing infrastructure, such as lamp posts, signposts etc. In such embodiments, the existing infrastructure may take the place of a support to support features of the system contained within the hollow structure, with the hollow structure being formed around the existing infrastructure.

FIG. 10 shows an embodiment of a three-dimensional image formation system 1000 according to an aspect of the invention. The system 1000 comprises a display screen 1080, and a scattering medium producing device 1085. The display screen 1080 is configured to be viewed through a scattering medium produced by the scattering medium producing device 1085, and the system 1000 is configured such that a thickness of the scattering medium through which the display screen 1080 is viewable is variable with respect to a viewing angle from a point P.

In the embodiment shown, the display screen 1080 is an LCD screen. In alternative embodiments, the display screen may be any suitable display screen, such as an LED screen.

In the embodiment shown, the display screen 1080 and the scattering medium producing device 1085 are both contained within a hollow structure 1005. The hollow structure 1005 is a hollow columnar structure as described with respect to the aspect of the invention in FIGS. 1 to 9, and the material from which the hollow structure is manufactured is transparent so as to allow the display screen 1080 to be viewable. In alternative embodiments, the display screen and the scattering medium producing device may be contained within a hollow structure of any suitable shape, for example a box or drum.

In alternative embodiments, the hollow structure may be a double walled structure, wherein the display screen 1080 is contained within the inner wall of the double walled structure, and the scattering medium producing device is contained within the outer wall of the double walled structure (i.e. between the inner and outer walls of the double walled structure). In such an alternative embodiment, the scattering medium may be contained between the inner and outer walls of the double walled structure. In alternative embodiments, the display screen and the scattering medium producing device may not be contained within a hollow structure.

In the embodiment shown, the scattering medium produced by the scattering medium producing device is contained within the hollow structure 1005 and fills the space contained within the hollow structure 1005.

In the embodiment shown, display screen 1080 is covered by an elongated semi-circular cover 1020 to separate the display screen 1080 from the scattering medium produced by the scattering medium producing device 1085. In the embodiment shown, the cover 1090 is manufactured from a transparent material, such as a transparent plastic. The display screen 1080 is waterproof. In alternative embodiments, the display screen may not be covered.

In alternative embodiments, the hollow structure may be a double walled structure. The display screen may be located within an inner wall of the double walled structure, whilst the scattering medium is contained within (and fills the space between) the inner and outer walls of the double walled structure.

In alternative embodiments, the display screen 1080 may be mounted on a support 1075 located within the hollow structure 1005. The inner wall of the double walled structure may form a housing of transparent material that may substantially surround the display screen 1080. The housing may substantially surround the display screen 1080 in all radial directions (relative to the hollow columnar structure 1005), and the housing may extend across some or all of the full height of the display screen 1080 in an axial direction (relative to the hollow columnar structure 1005). The housing may also be mounted on the support 1075. In such embodiments, the housing does not extend the full height or length of the outer wall of the hollow structure 1005. Therefore, below a lower end of the housing, the hollow structure may be considered to be a single walled structure. In such embodiments, the other components (e.g. the scattering medium producing device 1085) of the system 1000 may be located below the lower end of the housing. In this way, the other components of the system 1000 may be contained within the outer wall of the double walled structure, but not located within the inner wall of the double walled structure. Such embodiments could be considered to be a housing containing the display screen 1080, suspended within the outer walls of a hollow structure.

In the embodiment shown, the scattering medium is produced by a scattering medium producing device 1085 located behind the display screen 1005 relative to a position of a viewer. In alternative embodiments, the scattering medium may be produced at any location relative to the display screen 1080. In alternative embodiments utilising a curved display screen spanning a full 360°, the scattering medium may be produced by a scattering medium producing device located within the centre of the space formed by the curved display screen. In such alternative embodiments, the curved display screen may be located within an inner wall of a double walled structure, or the curved display screen itself may form the inner wall of the double walled structure. Various components and features of the system 1000, in addition to the scattering medium producing device, may be contained within the space created by the curved display screen spanning 360°. In alternative embodiments utilising a curved display screen spanning less than 360°, the scattering medium may be produced by a scattering medium producing device located at the centre of the curvature of the curved display screen (i.e., the common point of the radius of curvature of the curved screen).

When a viewer views the display screen 1080, through the scattering medium produced by the scattering medium producing device, from a viewing point, the system 1000 is configured to produce a display wherein a two-dimensional image displayed by the display screen 1080 is given a three-dimensional effect. This effect is produced by the viewer viewing the two-dimensional image displayed by the display screen through different thicknesses of scattering medium at different viewing angles. A schematic of this effect is shown in FIG. 10.

As shown in FIG. 10, when a viewer views the display screen 1080 through the scattering medium, the image displayed by the display screen 1080 is viewed through different thickness of scattering medium at different angles. An increased thickness of scattering medium through which the image is viewed results in an increased amount of scattering of light from the image displayed by the display screen 1080. The result of this phenomenon is the viewer sees a three-dimensional image effect produced by the merging of the views formed at different viewing angles. The light from the image displayed on the display screen 1080 is scattered so that the edge of the screen appears blurred, and the image appears to the viewer as though a three-dimensional object is floating in the scattering medium. The image appears holographic in its nature.

The three-dimensional image effect is further enhanced by matching the colour of the scattering medium to the colour of the display screen 1080 backlight. In alternative embodiments, the colour of the scattering medium may be altered by embedding light sources within the scattering medium. The background colour of the display screen 1080 may then be altered to match the colour of the scattering medium.

In the embodiment shown, the display screen 1080 is a flat display screen displaying an image from only one side (towards the point P in the embodiment shown). If the three-dimensional image formation system is contained within a hollow structure, the same visual effect (i.e. changing a viewer's perception of an image from two-dimensional to three-dimensional) is achieved whether the hollow structure is single walled or double walled.

FIG. 11 shows an embodiment of a three-dimensional image formation system 1100. In the embodiment shown, a display screen 1180 is a curved screen, able to display an image across all of the 360° rotational position that a viewer may view the system screen from. A scattering medium producing device 1185 is positioned within the space created by the 360° display screen 1180. The three-dimensional effect caused by viewing an image through different thicknesses of scattering medium may be enhanced further in this alternative embodiment utilising a curved screen, as the change in scattering medium thickness is increased with the same change in viewing angle when compared to a flat display screen. In the embodiment shown, the system 1100 further comprises, and is contained within, a hollow structure 1105. In alternative embodiments, a curved screen may only be able to display an image across part of the 360° rotational position that a viewer may view the system from. In alternative embodiments, the system may not be contained within a hollow structure.

In the embodiment shown, the curved display screen 1180 spanning 360° may be considered to form the inner wall of a double walled structure, with the hollow structure 1105 forming the outer wall of the double walled structure. As shown, the scattering medium producing device 1185 is positioned within the internal space formed by the curved display screen 1180. This embodiment reduces the need for a separate inner wall or housing in order to contain the curved display screen 1180 and/or any other components of the system 1100.

In alternative embodiments, a different visual effect may be produced by projecting an image onto a surface of a display device, and providing a scattering medium behind the display device. For example, an image could be projected onto an outer surface of a hollow structure whilst the hollow structure itself is filled with a scattering medium.

In alternative embodiments, a transparent display screen could be connected to an inner or outer surface of the hollow structure (or the inner or outer surface of the outer wall of a double walled hollow structure), while the hollow structure itself (or the space between the inner and outer walls of a double walled structure) is filled with a scattering medium.

In the embodiment shown, the scattering medium is a mist of fluid droplets.

Combining one or more features of the first aspect of the invention with one or more features of the third aspect of the invention results in a combined air pollution treatment and display system. For example, the three-dimensional image formation system could be located within a hollow structure. Providing the three-dimensional image formation system in a hollow structure could provide protection from external conditions such as wind damage (if located in an external area). The hollow structure could also help the scattering medium to retain a particular shape or structure. This could enhance the effect of the display screen being viewable through different thicknesses of scattering medium at different viewing angles.

An embodiment of such a combined system is shown in FIG. 12. The system 1200 comprises a hollow columnar structure 1205, a fluid reservoir 1210, one or more fluid outlets 1215 (not shown), an air inlet 1220, an air outlet 1225 with a filter 1230 (not shown), a secondary fluid outlet 1240, a fluid pump 1245, one or more fluid baths 1250 (not shown), a fluid cleaning device 1265, a support 1275 on which the one or more fluid outlets 1215, the secondary fluid outlet 1240, the fluid baths 1250, a display screen 1280, and LED light sources 1295 (for providing backlighting to the fluid droplets produced by the one or more fluid outlets) are supported.

In alternative embodiments, however, the three-dimensional image formation system does not need to be located in a hollow structure. The scattering medium producing device may be configured to produce a scattering medium confined to a particular physical space (e.g. by forming cylindrical or other shaped walls of scattering medium in front of the display screen, for example by using air flows to confine the location of the scattering medium).

In the embodiment shown, the scattering medium producing device of the combined air pollution treatment and display is the one or more fluid outlets 1215 of any embodiment of the first aspect of the invention. The spray of fluid droplets produced by the one or more fluid outlets 1215 may be utilised as the scattering medium used to produce the three-dimensional imaging effect according to the second aspect of the invention.

The display screen 1280 of the combined air pollution treatment and display system 1200 being supported by the support 1275 of the first aspect of the invention, as well as the one or more fluid outlets 1215 and/or the secondary fluid outlet 1240 and/or the fluid baths 1250 being supported on the support 1275, allows the power and/or fluid utilities required for each of those components to be provided in the internal space of the support 1275. This maximises the available space for fluid droplets to interact with, attract and remove pollutant particles from the air flowing through the system 1200 (increasing the collection efficiency of the system) whilst simultaneously providing a display for a viewer to see.

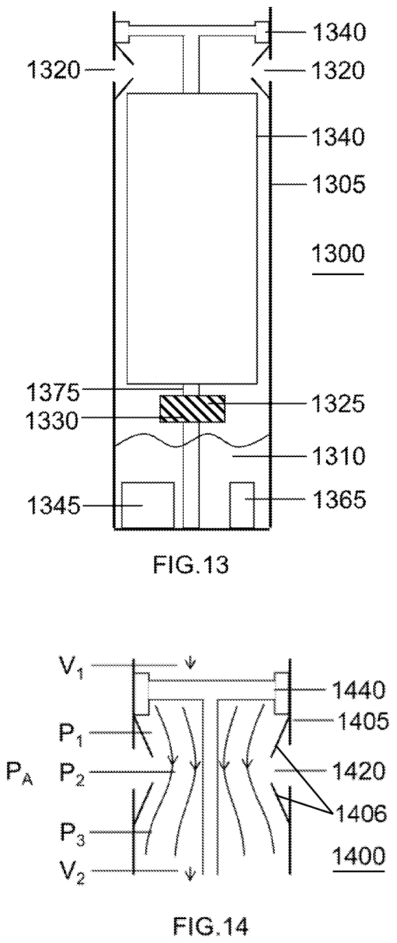

FIG. 13 shows an embodiment of a combined air pollution treatment and display system 1300. The system 1300 comprises an air inlet 1320 that is provided separately from an open end of a hollow structure 1305. A filter 1330 located in an air outlet 1325 is shown as a mesh filter. Other features displayed in FIG. 13 correspond to features shown in FIG. 12. As above, the scattering medium producing device of the combined air pollution treatment and display can be provided by one or more fluid outlets (not shown) of any embodiment of the first aspect of the invention. The spray of fluid droplets produced by the one or more fluid outlets may be utilised as the scattering medium used to produce a three-dimensional imaging effect.

In the embodiment shown, the air outlet 1325 and the filter 1330 are arranged such that the air outlet 1325, the filter 130 and the display screen 1380 are all located at the same angular location about a longitudinal axis of the hollow structure 1305. In this embodiment, a viewer viewing the display screen 1380 of the system 1300 (from a direction perpendicular to the plane of the display screen 1380) will also be directly facing the air inlet 1325 and the filter 1330. In this embodiment, air expelled from the system 1300 back into the external environment is directed toward a viewer directly facing the display screen 1380. This may allow the system 1300 to provide a cooling effect to a viewer if there are high external temperatures. This may also allow for a “four-dimensional” experience for the viewer, comprising the three-dimensional image viewable via the system 1300, and a tactile or sensory experience (providing the so-called “fourth dimension” of the experience provided by the air flow exiting from the system 1300 via the air outlet 1325. This experience may be enhanced by positioning a fan 1345 near the outlet 1325 to facilitate and direct increased air flow through the air outlet 1325 and the filter 1330.

In alternative embodiments, the air outlet 1325 and the filter 1330 may be located at a different angular location about the longitudinal axis of the hollow structure 1305 than that of the display screen 1380.

FIG. 14 shows an enlarged portion of the upper part of FIG. 13. A ring-shaped secondary fluid outlet 1440 is located in the open end of the hollow structure 1405. The air inlet 1420 is an aperture located around the circumference of the hollow structure 1405 proximate the open end of the hollow structure 1405. Baffles 1406 extending from the inner surface of the wall of the hollow structure 1405, located both above and below the air inlet 1420, form a narrowed internal portion of the hollow structure 1405. The baffles 1406 direct air entering the system 1400 through the open end of the hollow structure into the narrowed internal portion of the hollow structure 1405, utilising the Venturi effect (explained below).

P₁ is an air pressure of air entering the hollow structure 1405 through the open end. As the air is directed into the narrowed internal portion of the hollow structure 1405 formed by the baffles 1406, the velocity of the air flowing through the system increases, and is balanced by a drop in air pressure to P₂, where P₂ is a lower air pressure than P₁. As the air flowing through the narrowed internal portion is moving at a greater velocity than air at the open end of the hollow structure 1405 (and is at a lower air pressure), there is a magnification of the air flow because air from the external environment is sucked in through the air inlet due to the pressure difference between the atmospheric pressure Pₐ and P₂, where Pₐ is greater than P₂. The resulting pressure P₃ lower in the hollow structure 1405 is greater than P₂. The Venturi effect therefore enhances air flow through the system 1400, with air velocity inside the hollow structure 1405, V₂, greater than when it enters at the aperture V₁ (V₂>V₁), and enables a higher throughput of air to be cleaned.

As can also be seen from FIG. 14, the fluid output from the secondary fluid outlet 1440 is also directed by the baffles 1406 forming the narrowed internal portion of the hollow structure 1405. The synergistic behaviour of the entrainment of air caused by the flowing fluid produced by the secondary fluid outlet 1440 and the magnification of the air flow caused by the Venturi effect enables a higher throughout of air to be cleaned by the system 1400.

In the embodiment shown, an angle of less than or equal to 15° between the baffles 1406 and the external walls of the hollow structure 1405 is shown. An angle in this range is provided to optimise the utilisation of the Venturi effect without interrupting the flow of fluid and air through the narrowed internal portion of the hollow structure 1405. In alternative embodiments, however, angles of above 15° (for example, between 15° and 90°) between the baffles 1406 and the external walls of the hollow structure 1405 may be provided.

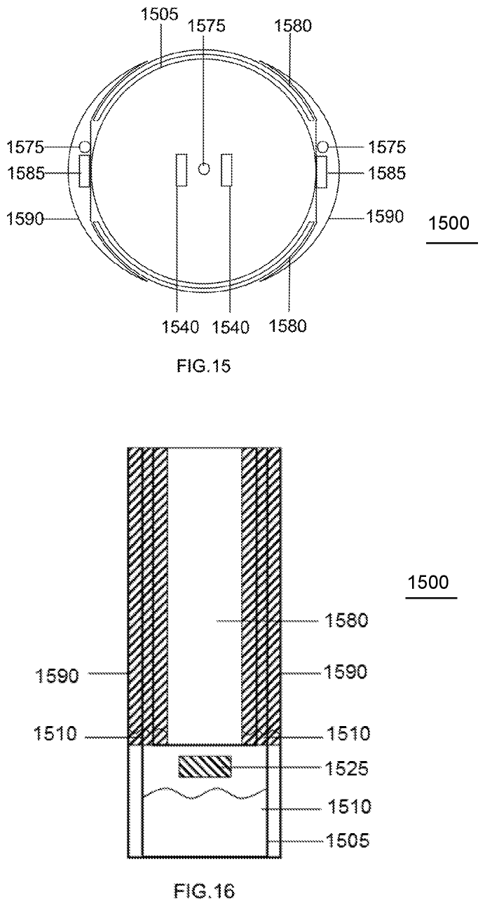

FIG. 15 shows a top profile of another embodiment of a combined air pollution treatment and display system 1500. The system 1500 comprises a plurality (e.g. two) curved display screens 1580 which are located outside a hollow structure 1505 and are overlapped/sandwiched on either side by separate secondary mist chambers 1590. Each curved display 1580 spans a portion of the available 360° of rotational display space that may be utilised. The full 360° of available rotational display space is not utilised—a gap g is located between the rotational positions of the ends of each of the curve display screens 1580. In this embodiment, the two curved display screens 1580 mounted to the hollow structure 1505 could be considered to form a partial outer wall of a triple walled structure. In this embodiment, the secondary mist chambers 1590 are self-contained and generate their own scattering medium with tertiary fluid outlets 1585 which have the same/similar functionality as the secondary fluid outlets 1540. The secondary mist chambers 1590 are intended to contain the scattering medium generated by the scattering medium producing device 1585, which is not directly involved in pollution cleaning, but meant primarily for the light scattering 3D visual effect. The secondary mist chambers 1590 are located and mounted on either side of the central hollow structure 1505, with the curved screens 1580 located between the secondary mist chambers 1590 and the central hollow structure 1505. The secondary mist chamber 1590 walls can be made out of transparent or translucent materials. Partially locating the secondary mist chambers 1590 in front of the curved screens 1580 means the 2D images from the curved screens 1580 will partially be seen through the scattering medium of the secondary mist chambers 1590 thus producing the desired 3D visual effect. Each secondary mist chamber 1590 spans a portion of the available 360° of rotational display space that may be utilised. The overlap of the secondary mist chambers 1590 with the curved screens 1580 can be varied to achieve a desired visual effect. The shape and thickness of the secondary mist chambers 1590 can be altered so as to vary the space available for the scattering medium, to achieve the desired visual effect. In this embodiment the secondary mist chambers 1590 may have their own integrated supports 1575, that are separate from the central hollow cylinder 1505 support.

In such double or triple walled structure embodiments comprising a partial inner wall (formed either by one or more curved display screens, or a separate structure provided to enclose or cover one or more curved display screens), fluid outlets or a scattering medium producing device may be located either inside of or outside of the partial inner wall. In such embodiments, a fluid pipe may be located within the partial inner wall which may be used to supply a spray of fluid droplets to the air flowing through the system. This negates the need for one or more potentially lengthy fluid connections between a central fluid conduit located within a complete inner wall of a double walled structure, and one or more fluid outlets (of the scattering medium producing device) located in the space between a complete inner wall and a complete outer wall of a double walled structure. In this way, fluid distribution to the one or more fluid outlets is simplified.

FIG. 16 is a front view of the same embodiment as FIG. 15, showing the overlap of the secondary mist chambers 1590 over the curved screen 1580. FIG. 16 also shows the system has features equivalent to those of earlier embodiments, including a hollow structure 1505, a fluid reservoir 1510, and a fan 1525.

In such double or triple walled structure embodiments comprising a partial inner wall (formed either by one or more curved display screens, or a separate structure provided to enclose or cover one or more curved display screens), fluid outlets or a scattering medium producing device may be located either inside of or outside of the partial inner wall. In such embodiments, a fluid pipe may be located within the partial inner wall which may be used to supply a spray of fluid droplets to the air flowing through the system. This negates the need for one or more potentially lengthy fluid connections between a central fluid conduit located within a complete inner wall of a double or triple walled structure, and one or more fluid outlets (of the scattering medium producing device) located in the space between a complete inner wall and a complete outer wall of a double walled structure. In this way, fluid distribution to the one or more fluid outlets is simplified.

In aspects and embodiments, “display screen” is intended to be construed broadly. In alternative embodiments, the system may comprise one or more light sources either in place of, or in addition to, the display screen. The one or more light sources may be arranged to form a three-dimensional array of lights within the hollow structure to produce a visual display for a viewer. Light scattered by the fluid droplets may provide a visual effect similar to the holographic effect produced when rendering a three-dimensional image from a two-dimensional image displayed on a screen.

This combined system could be used to provide advertising images and videos whilst also providing a treatment for air pollution. This combined system could be used to create a revenue stream for stakeholders (e.g. councils, or any party interested in installing the system) whilst simultaneously cleaning the air of pollutant particles. Such a system decreases the barriers to effective pollution treatment, and allows the system to be scalable (i.e. widely implemented) due to the commercial revenue created by the advertising displayed by the system.

The combined air pollution treatment and advertising system opens up both new advertising spots and increased advertising real estate. A single system (combined air pollution treatment and display system) may be used as a stand-alone display unit, or a static or moving image may be spread across an array of systems to use a whole environment as one singular advert larger than the size of a single display screen. The feature of the system being modular (i.e. multiple systems may be stacked on top of one another, or connectable side by side through use of complimentary connecting features located on each of the systems) easily enables an array of systems to be installed.

The combined system could therefore be implemented in a distributed network across an outdoor environment, and for maximum impact can be placed in pollution hotspots (i.e. areas of slow moving traffic) in order to help drive high advertising revenue. The combined system could also be used inside buildings to tackle indoor air pollution.

From reading the present disclosure, other variations and modifications will be apparent to the skilled person. Such variations and modifications may involve equivalent and other features which are already known in the art of air pollution treatment and/or three-dimensional image formation systems, and which may be used instead of, or in addition to, features already described herein.

Although the appended claims are directed to particular combinations of features, it should be understood that the scope of the disclosure of the present invention also includes any novel feature of any novel combination of features disclosed herein either explicitly or implicitly or any generalisation thereof, whether or not it relates to the same invention as present claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and any reference signs in the claims shall not be construed as limiting the scope of the claims.

1. A three-dimensional image formation system comprising:
a display configured to provide or display an image; and
a scattering medium producing device configured to produce a light scattering medium;
wherein the display is configured to be viewed through a said scattering medium to create a three-dimensional image; and
wherein the system is configured such that a thickness of the scattering medium through which the display is viewable is variable with respect to a viewing angle.

2. The three-dimensional image formation system of claim 1, wherein the scattering medium producing device is configured to produce a mist of fluid droplets.

3. The three-dimensional image formation system of claim 1, further comprising one or more fluid outlets configured to produce the mist of fluid droplets.

4. The three-dimensional image formation system of claim 3, wherein the one or more fluid outlets are configured to vary a fluid droplet size of the spray of fluid droplets.

5. The three-dimensional image formation system of claim 3, further comprising a hollow structure comprising an air inlet and an air outlet.

6. The three-dimensional image formation system of claim 5, further comprising a filter at or near the air outlet, configured to remove fluid droplets from air passing through the air outlet.

7. The three-dimensional image formation system of claim 5, wherein the hollow structure is a hollow columnar or tubular structure.

8. The three-dimensional image formation system of claim 7, wherein an end of the hollow columnar structure is open; and
i) the air inlet or outlet is formed by or provided at the open end; and/or
ii) the air inlet or outlet is located proximate the open end.

9. The three-dimensional image formation system of claim 6, further comprising an aperture in the hollow structure, wherein the air outlet or inlet is formed or provided by the aperture.

10. The three-dimensional image formation system of claim 5, further comprising a fan configured to assist air flow from the air inlet to the air outlet.

11. The three-dimensional image formation system of claim 5, further comprising a secondary fluid outlet configured to flow across an internal surface of the hollow structure in a direction substantially corresponding to the direction of air flow from the air inlet to the air outlet.

12. The three-dimensional image formation system of claim 5, wherein a portion of the hollow structure forms a fluid reservoir, and optionally or preferably wherein the air outlet is located above the level of a fluid in the fluid reservoir.

13. The three-dimensional image formation system of claim 12, further comprising a fluid pump configured to pump clean or treated fluid from the fluid reservoir to each of the one or more fluid outlets and/or the secondary fluid outlet.

14. The three-dimensional image formation system of claim 3, wherein one or more of the fluid outlets comprises an ultrasonic atomiser; and, optionally or preferably, further comprises a variable nozzle sprayer.

15. The three-dimensional image formation system of claim 3, wherein one or more of the fluid outlets is located in a fluid bath and configured to produce a spray of fluid droplets using fluid contained in the fluid bath; and, optionally or preferably,
wherein the system is configured to maintain the level of the fluid in the fluid bath at a constant level.

16. The three-dimensional image formation system of claim 15, further comprising a support, wherein the one or more fluid outlets and/or the secondary fluid outlet and/or the fluid baths are provided on the support.

17. The three-dimensional image formation system of claim 11, further comprising a fluid cleaning device located in the fluid reservoir.

18. The three-dimensional image formation system of claim 17, wherein the fluid cleaning device is one of a UV light cleaning device, a mechanical filtering device, or a chemical-based cleaning device

19. The three-dimensional image formation system of claim 11, further comprising a polluted fluid chamber configured to store fluid which has been output from the one or more fluid outlets and/or the secondary fluid outlet separately from fluid in the fluid reservoir.

20. The three-dimensional image formation system of claim 5, wherein the air inlet is configured to assist air entering the structure and/or has rounded or curved edges.

21. The three-dimensional image formation system of claim 1, wherein the display is a display screen and, optionally or preferably, is one of a flat display screen and a curved display screen.

22. The three-dimensional image formation system of claim 1, wherein the scattering medium producing device is located behind the display relative to a viewpoint of a viewer.
